(19) United States
(12) Patent Application Publication
(10) Pub. No.: US 2016/0210607 A1
(43) Pub. Date: Jul. 21, 2016

(54) System and Method to Provide Prison Inmates With Interactive Court Forms via a Network Web Server

(71) Applicant: Lonnie Lamont Griffin, Pekin, IL (US)

(72) Inventor: Lonnie Lamont Griffin, Pekin, IL (US)

(21) Appl. No.: 14/597,383

(22) Filed: Jan. 15, 2015

(51) Int. Cl. G06Q 20/22; G06F 17/30

(52) U.S. Cl. CPC G06Q 20/22; G06F 17/30011; G06Q 50/18

(57) ABSTRACT

The present invention is a network architecture or framework that supports Web content distribution on a limited scale. The network framework comprises a set of servers operating in a coordinated manner. The inventive framework allows a Content Service Provider to replicate content retrieved from a Content Provider, i.e., a court, and provide that content to prison inmates on a computer system and device suitable for prison and correctional environments. The content comprises basic court forms common to most all prison inmates. The system and device suitable for prison and correctional environments would permit the prison inmate to fill in the form and electronically forward that form to a court.

### CROSS-REFERENCE TO RELATED APPLICATIONS

This application claims the benefit of the Provisional Patent Application filed 2014 Jan. 27, application Ser. No. 61/965,752, by Lonnie Lamont Griffin, the present inventor, which is incorporated by reference.

### BACKGROUND OF INVENTION

1. Field of the Invention

This Invention relates generally to information retrieval and forwarding via an internet computer network. More particularly, the invention relates to an innovative communications medium whereby prison inmates can view, select, complete and electronically forward basic court forms to a court using a computer Interface.

2. Description of Related Art

By some accounts, it is estimated that them are between 1.8 million (Wall Street Journal, Feb. 11, 2013, A3) and 2.3 million (Newsweek, Sep. 19, 2011) prisoners incarcerated in the United States. As a corollary, these prisoners have litigation pending in court or initiates litigation in one or more of the thousands of courts disseminated throughout the United States after they are sent to prison. To date, prison inmates typically have to submit their legal court forms in paper format due to the absence of access to electronic filing means. Most, if not all, of that paper formatted litigation is processed through the United States Postal Service (USPS) mail delivery system. Or in limited circumstances, by private mail carriers such as Federal Express. A notable exception is when the court form is delivered hand-to-hand from an attorney (or other officer of the court) to a prison inmate. However, many courts have evolved to an electronic document riling system (EFS) for legal documents. In one embodiment, the EFS system is described as the Case Management/Electronic Case Filing (CM/ECF) system. See generally Federal Rules of Criminal Procedure, Rules 49, 49.1; Federal Rules of Civil Procedure, Rules 5(b)(2)(E), 5(b)(3) & 5(d)(3). Federal Rules of Appellate Procedure. Rule 25(a)(D) As a result, many courts end up having to scan paper documents, submitted by prison inmates into their electronic case file so they become available to other court personnel (and the public) in the same way as documents initially filed in electronic form.

The above-described prior art has the following disadvantages:
documents must be hand-written or typed by the prison inmate prior to mailing
envelope must be addressed and affixed with postage
mailing package subject to be lost, damaged or stolen
mailing package must go through security screening prior to being delivered to a receiving court
mailing package must go through security screening prior to being delivered from and to the prison inmate
uncertainty of receipt or delivery of time-sensitive court documents
arrangements need to be made before hand with prison authorities for visitation of prison inmate
paper documents must subsequently be scanned into an electronic case file

### BRIEF SUMMARY OF THE INVENTION

An embodiment of the present invention provides a system, method and device for prison inmates to view, select, input data and electronically forward preformatted basic court forms to a court from a network computer system. The Content Service Provider (“CSP”) hosts a Web server or series of servers that retrieves and maintains consequent access to the preformatted court forms provided by the Content Provider (“CP”) i.e., the court. A client machine system (such as an Ethernet) displays information that identifies the preformatted form and displays an indication of an action (e.g., inputting data into insertion spaces) that the prison inmate is to perform to complete the court form. In response to the indicated action being performed, the client machine system sends to the Web server system of the “CSP” a request to forward the completed form to the court. In view of this summary, the contemplated system, method and device provides an option for prison inmates that is currently not available as prior art. Accordingly, a network computer system of the type envisioned for prison inmates will be or become apparent to one skilled in the art upon review of the description and drawings

### BRIEF DESCRIPTION OF THE SEVERAL VIEWS OF THE DRAWINGS

FIG. 1 is a representative system in which the present invention is implemented.

FIG 2 is a simplified flowchart illustrating a method by which the user operates the system.

FIG. 3 is an illustrated typical first page embodiment of a court form for prison inmates

FIG. 4 is an illustrated representation of a completed court form.

REFERENCE NUMERALS FOR DRAWINGS

| | |
|---|---|
| 10-Web Server | 12-Data processor |
| 13-Graphics processor | 14-Operating System |
| 16-Web Server Program | 18-Application Programming |
| 20-Client Server | Interface |
| 24-Remote Desktop Gateway Server | 22-Client Machine |
| 28-Low-Level Court Content Server | 26-Replicating Server |
| 32-High-Level Court Content Server | 30-Mid-Level Court Content |
| 36-Illustrated Court Form | Server |
| 40-Illustrated Prisoner Image | 34-Satellite Network |
| | 38-Spaces |
| | 42-Hyperlinked Space |

### DETAILED DESCRIPTION OF THE INVENTION

### System

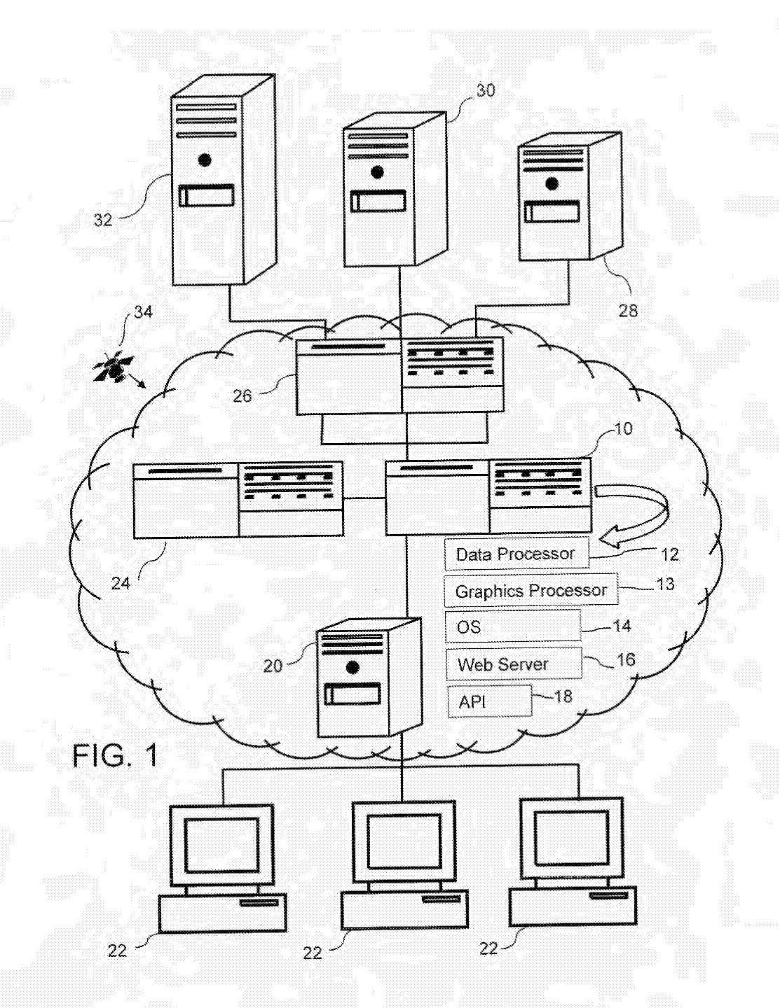

FIG. 1 shows a representative diagram of a network system whereby prison inmates may access preformatted basic court forms 36 and electronically forward such forms 36 to a court. A client machine 22 is connected to a client server 20 via a Local Area Network (LAN). Although illustrated as a LAN in FIG. 1 it should be appreciated that the communications medium could take a variety of other forms, for example, an ordinary telephone line, or a private leased fins. The access point for the client machine 22 can be bested in an area away from the client machine 22. The client server 20 supports files in the form of hypertext documents. The client server 20 connected to a Web server 10 at a Content Service Provider (“CSP”). The Web server 10 is one of a plurality of servers maintained by the “CSP”. For example, the “CSP” also maintains a Remote Desktop Gateway server 24 and one or more replicating servers 26. FIG. 1 The Web server 10 is connected to the Content Provider (“CP”), i.e., the low, mid, and high level court servers 28, 30, and 32 via a Wide Area Network (WAN) internet communication network. At present, I believe that satellite network connection 34 embodiments, similar to the broadband satellite internet service offered by ViaSat of Carlsbad, Calif. would operate most efficiently, but other embodiments are also satisfactory.

The representative Web server 10 is a computer comprising a data processor 12, a graphics processor 13, an operating system 14 and a Web server program 16. A Web server 10 supports files (collectively referred to as a “Web” site) in the form of hypertext documents. The Web server 10 also includes an Application Programming Interface (API) 18 that provides extensions to enable application developers to extend and/or customize the core functionality thereof through software programs including servlets or the like such as the Sun Java System Application Server from Sun Microsystems of Santa Clara, Calif.

As an example for a preferred embodiment for the present invention, the client server 20 can be preprogrammed with a passphrase or the like, such as the prison Inmates unique log-in information. The pre-determined log-in information may consist of a multi-digit Personal Access Code (PAC) and/or a mufti-digit Personal Identification Number (PIN) typically assigned to prison inmates or other similar profile indicia of an authorized user. The client machine 22 may also be equipped with a fingerprint scanner to further safeguard authorized usage. While many variations of access authorization can be implemented. I believe some combination of PAC and/or PIN numbers) along with consequent fingerprint identification would be the most secure at this time The authentication information, which is user-independent and included in the data file, is preferably, non-limitatively, encrypted.

In accordance with the preferred embodiment, the Web server 10 would comprise one or more FormEngines. The FormEngine is a Java framework for dynamic form creation and complex form processing for web applications. A FormEngine also allows data sharing between customizable on-line forms. Commensurate with the preferred embodiment, the Web server 10 comprises a Servlet Container. A Servlet Container is the component of a web server that interacts with Java servlets. The servlet is a Java programming language class used to extend the capabilities of a server. Although servlets can respond to any types of requests, they are commonly used to extend the applications hosted by web servers, so they can be thought of as Java Applets that run on servers instead of in web browsers. A Servlet Container is responsible for managing the lifecycles of servlets, mapping a URL to a particular servlet and ensuring that the URL requester has the correct access rights. A Servlet Container sufficient to meet the embodiment of the present invention can be of the type or similar to the Sun Java System Web Server from Sun Microsystems of Santa Clara, Calif., or that developed by Docker, Inc. of San Francisco, Calif.

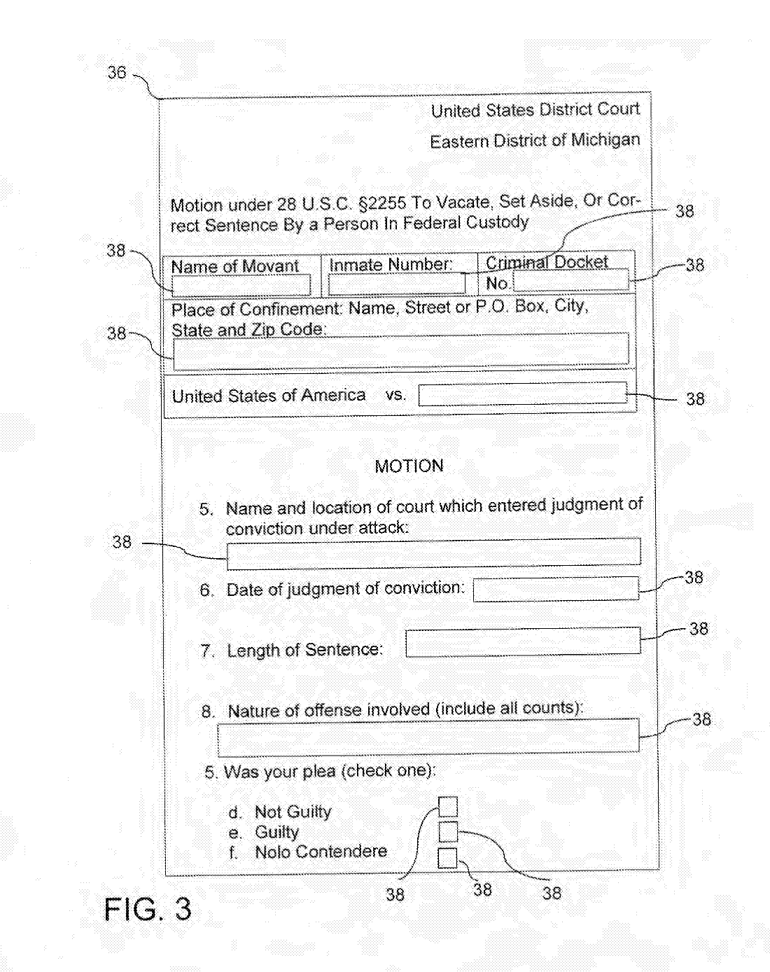

A form is considered to be essentially a container for data and implies an associated process. The form engine integrates the form, the data, and the processing regardless of the appearance of the form, the type or significance of the data and the processing that follows collection of the data. Since the completed court form 36 may contain sensitive information, both the prison inmates and the courts want to ensure the security of such information. FIG. 3. Security is a concern because information transmitted over the Content Delivery Network (CDN) may pass through various intermediate computer systems on its way to its final destination. FIG. 1 CDN's are systems of computers strategically placed at various locations to maximize the efficient delivery of information over the internet to users accessing the network. The information could be intercepted by an unscrupulous person at an intermediate system. To help ensure the security of the sensitive information, various encryption techniques (such as a Network Security Key) should be used when transmitting such information between a client machine 22 system and a server computer 10 system. Even though such encrypted information can be intercepted, because the information is encrypted, it is generally useless to the interceptor. Nevertheless, there is always a possibility that such sensitive information may be successfully decrypted by the interceptor. Therefore, it would be desirable to minimize the sensitive information transmitted via the “CDN”. In accordance with the preferred embodiment the security can be managed through the Remote Desktop Gateway server 24, of which the Web server 10 is comprised using an Advanced Encryption Standard (AES). Security can also be enhanced using HTTPS protocol (Hypertext Transfer Protocol/Secure Sockets Layer) or a virtual private network (VPN). A VPN is a private, encrypted communications funnel that operates inside a public or shared network. An exemplary example of a VPN is the PureVPN offered by purevpn.com.

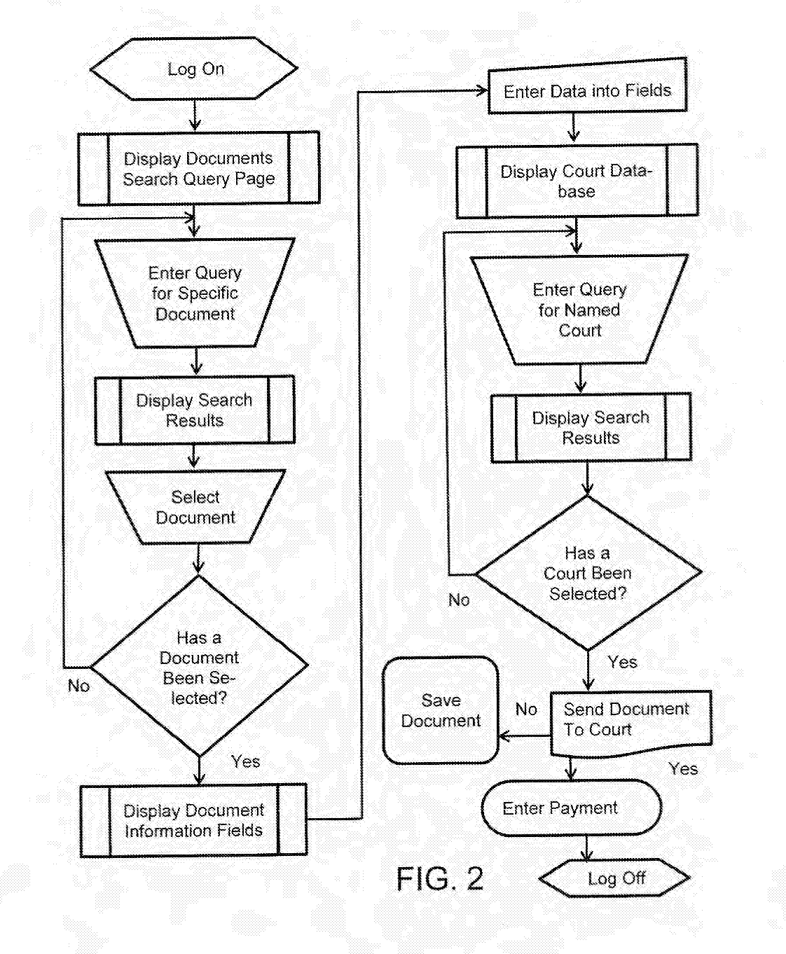

In the preferred embodiment, the client machine 22 and/or client server 20 shall be programmed with a Portable Document Format (PDF) form filler software such as CutePDF. “PDF” is the de facto standard for electronic forms and forms exchange While other methods of form manipulation exist, I believe the “PDF” is the most viable at this time. However, skilled network providers and programmers can establish and write many programs to customize a network and applications suitable for prison inmates and will understand that FIGS. 1 and 2 is a greatly simplified example used to demonstrate the principles of the embodiment.

According to a contemplated embodiment, the Web server 10 would also contain an active data packet area An active data packet area is an area located in any data storage area suitable for input/output operations. The active data packs may be formulated to represent a different data file for each court form 38 of each court. According to a preferred embodiment of the invention, the application data file describes the format of each court form 36, and the forms engine displays information from the database in the format prescribed by the application data file. The forms engine automatically uses the application data file to produce the requested court form 38 in a user-friendly format.

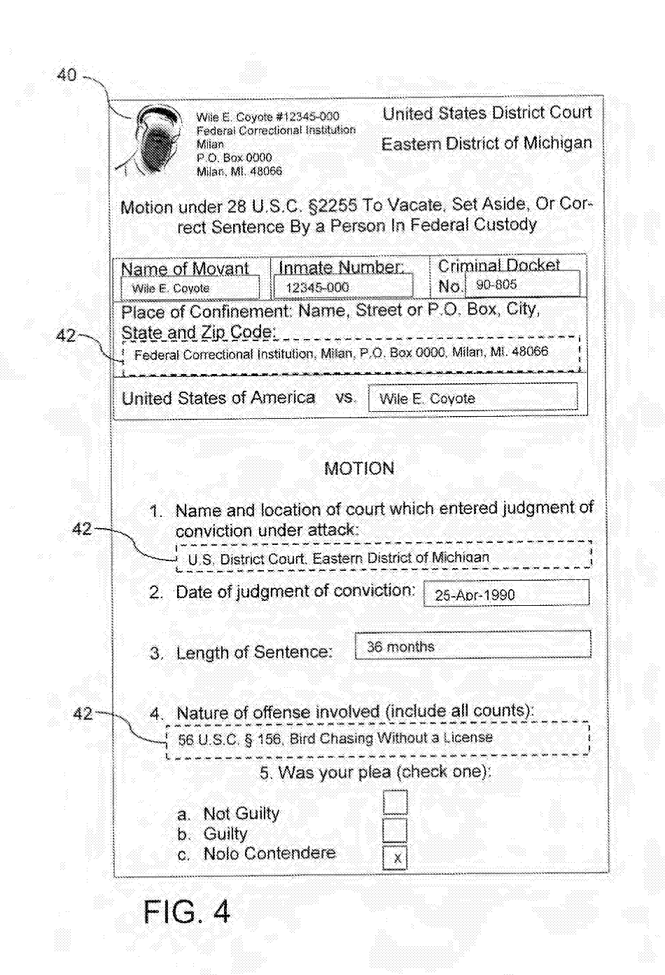

In the preferred embodiment, the Web server 10 would also contain one of more active data files representing a plurality of United States Code titles and numbers (e.g. 28 U.S.C. §2255); text from the U.S. Constitution phrases and strings of text commensurate with the information to be entered into the spaces of the form 36. FIG. 4.

The Web server 10 would also contain data files consisting of a plurality names and addresses of available courts FIG. 3; names and addresses as defined not only by their United States Postal Service (USPS) listing (for prison inmate simplicity), but also their by their URL address However, the URL addresses need not be visible to the prison inmate on the client machine 22. At present, I believe that an icon button representative the court would be the most secure and effective mode of selection.

The representative client machine 22 is a personal computer that is x86-, PowerPC™- or RiSC-based (Reduced Instruction Set Computer) that includes an operating system such as Microsoft Windows 7 or the like, that includes a Web browser such as Internet Explorer 8. A client machine 22 may also be a notebook computer, a hand-held computing device (e.g., a PDA), or arty other such device correctable to the computer network FIG. 1. While standard client machines 22 with keyboards are sometimes available to prison inmates, I believe a kiosk-styled apparatus with a menu-driven window (i.e., graphical user interface, or GUI) would be the most effective at this time.

In accordance with the preferred embodiment, the representative client machine 22 shall be equipped with a browser. Browsers are a known special-purpose software application program used to access the servers of the network which effect the requesting of computer pages and the displaying of computer pages. A well-known browser is the internet Explorer available via Microsoft Windows applications. The purpose of a web browser is to read Hypertext Markup Language (HTML) documents and compose them into visible webpages. Presently, Web pages are typically defined using HTML. HTML elements form the building blocks of all websites. HTML allows images and objects to be embedded and can be used to create interactive documents. HTML is written in the form of HTML, elements consisting of tags within the Webpage content that control the displaying of text, graphics, controls, and other features. The browser does not display the HTML tags, but uses the tags to interpret the content of the page When a user of a computer indicates to the browser to display a Web page, the browser sends a request to the Web-site to transfer to the browser an HTML document that defines the requested Web page. When the requested HTML document is received by the user's server, the browser of the computer displays the Web page as defined by the HTML document. The HTML document may contain the Uniform Resource Locator (URL's of other Web pages available on the site or other server computer systems. Use of an HTML-compatible browser (e.g., Netscape Navigator, Microsoft Internet Explorer or, Firefox) at a client machine 22 involves specification of a link via the URL. The URL not only assists the process in facilitating the servers access to an HTML document (e.g., by executing appropriate communication protocols), but may also be provided with security means that prevent the server from accessing resources outside the specific HTML document area of the Web page.

### Method

The claimed method consists of replicating one or more of a court's preformatted forms, e.g., 36 to one or more “CSP” servers, e.g., 10 and offering access to those forms 36 to prison inmates via a client machine 22. FIG. 1. Upon receiving a query for a particular court form, the Web server 10 communicates with the servers of the low-level courts) 28, mid-level court(s) 30 and high-level court(s) 35 to locate the requested form 36. The Web server 10 of the “CSP” would communicate with the courts' servers 28, 30 and 32 using a secure Transmission-Control Protocol/Internet Protocol (TCP/IP) communications protocol, such as HTTPS/SSL, by means of network satellite communication. In accordance with the present invention, the court forms 36 would be replicated from the servers of low-level court(s) 28, mid-level court(s) 30 and high-level court(s) 32 to the severs 10, 24, and 26 of the “CSP” as “static files.” A “static file” is a file that is repeatedly transferred without changes. By severing the base court form 36 from the court's site as a “static file,” the court maintains control over the form's 36 structure. FIG. 3. The common behavior of the Web server 10 therefore is to fetch the base court form 36 from the servers 28, 30 and 32 of the courts.

According to one embodiment, the court must tag the URL of each court form 36 available for dissemination. Preferably the base court form 36 (or a copy thereof) is initially severed from the court's Web server, whereas a given number (or perhaps all) of the court and/or prison inmate-specific embedded tags are inserted at the “CSP's” servers in this embodiment, the court form 38 (or file) may then be validated by the Web server 10 before being sent to the client server 20. Once the Web server 10 fetches the court form 38 from a court, the Web server 10 stores (“caches”) it locally so it is available for subsequent requests for that form 36. Subsequent requests for the same form (e.g., FIG. 3) would be made available to the client server 20 using the “stored” request the court form 36 will be electronically transferred to the client server 20 as a text file.

According to the present invention, the representative client machine 22 would communicate with the Web server 10, via the client server 20, using a different secure TCP/IP. The Web server 10 then assigns a request identifier and associates the assigned request identifier with the query made by the prison inmate via client machine 22. The Web server 10 then sends to the client server 20 a form commensurate to the indicated query Upon locating the relevant form, the “CSP” server, e.g., 26 replicates the properly tagged form 38 on some, e.g., 10 or, all of its servers 24 and 26 and directs a prison inmate's request for one of the court forms 36 to an appropriate “CSP” server. The “CSP” servers then forward the form 36 to the client server 20. The client machine 22 then displays the form 36 to the prison inmate on a suitable display.

The severed form 36 would consist of basic court forms common to most all prison inmates. Basic court forms common to most all prisoners include, but is not limited to, Notices of Intent to Appeal; Motion for Appointment of Counsel; Writs of Habeas Corpus pursuant to 28 U.S.C. §2241; Motions to Vacate, Set Aside or Correct Sentence pursuant to 28 U.S.C. §2255. Motions for Authorization to File a Second or Successive 28 U.S.C. §2255 pursuant to 28 U.S.C. §2244; Motions and Declarations for Leave to Proceed in Forma Pauperis and; Motions to Modify a Term of Imprisonment pursuant to 18 U 5 C. §3582 or the like. See e.g., FIG. 3.

According to the preferred embodiment, the “CSP” shall program the Web server 10 to automatically populate the replicated court form 38 with spaces 38 (commonly referred to as “fields”) identifying the locations where the prison inmate must enter data. According to another preferred embodiment of the invention, the sequence of data to be inserted into the spaces 38 of the court form 36 is such as to be input by a computer-related device The computer-related device can also be any suitable device such as a keyboard or a mouse or touch-screen. However, according to the preferred embodiment of the invention, for security and suitability for a prison inmate, the sequence of data required to be input into the spaces 38 of the court form 38 may comprise digits and/or characters in plain text format.

A flowchart illustrating the preferred method for using the “CDN” is illustrated in FIG. 2. The client machine 22 is one of a plurality of machines which are accessible by a prison inmate which is illustrated by FIG. 1. In the preferred embodiment, the prison inmate accesses the Interface of the client machine 22 by using pre-determined log-information unique to each prison inmate. Upon acceptance of the prisoner's unique log-in information, the prison inmate may use the web browser of the client machine's 22 to locate a court form 36. The client machine's 22 web browser receives and displays the court form 36 to the prison inmate on the client machine's 22 display screen, in response to the selection of a court form 36, the client machine's 22 web browser will also make known (e.g., by highlighting) the required information spaces 38 on the court form 36 that prison inmates are generally required to complete FIG. 3. In the preferred embodiment, the space will contain a hyperlink 42 to the data files of the Web server 10. As the prison inmate uses the control element to populate the space 38 (field) of the court form, the space will display a hyperlink 42 to a specific data file on the Web server 10. Upon selection of the hyperlinked 42 field, the Web server 10 will display one or more United States Code titles and numbers (e.g., 28 U.S.C. §2255), text from the U.S. Constitution, phrases and strings of text (or other data) commensurate with the information to be entered into that particular space 38. FIG. 4. The data file information will be available for insertion into the fields 38 by means of, e.g., gestures or drag-and-drop. In accordance with the preferred embodiment, the client machine 22, via the Web server 10, will automatically procure the name and address of the prison where the inmate is incarcerated. FIG 3 and FIG 4.

in response lo an action by the prison inmate on the client machine 22, the Web server 10 receives a further request and embeds the profile indicia associated with the prison inmate on the court form 36. For example, each court form 38 may be branded with the court's name, location, prison inmate s name, prison registration number and/or digital image or likeness of the prisoner 40 at the “CPS” server FIG. 4 using HTTPS protocol (HTTPS/SSL) the “CPS” server 10 transmits the completed form 36 to a server associated with a Sow-level court 28, mid-level court 30 or, high-level court 32.

According to the preferred embodiment, the prison inmate shall be charged a fee for electronically forwarding any court form 36 to the court. Generally, prison inmates have access to digital mediums-of-exchange. These digital mediums-of-exchange sometimes take the form of debit credits deducted from the prison inmate's trust-fund account. A “trust-fund” account is an account created for the prison inmate upon his/her admission to prison whereby family or friends can deposit money for the prison inmate's use to purchase, among other things, commissary items such a postal stamps and food items, hygiene products, and to pay for telephone usage. Alternatively, the prison inmate can net credit to his or her trust-fund account by earning performance pay from prison fobs Typically, prison inmates debit credits are expendable in 0.05¢ increments.

### Advantages

Several advantages of one. or more aspects of my method, system are as follows;
the reduction or elimination of paper usage and filings by prison inmates with respect to certain basic court forms
creation of a uniform form filing system for use by prison inmates with respect to certain basic court forms
to provide clarity of the prison inmates legal argument with respect to the filing of certain basic court forms
the reduction or elimination of court personnel hawing to scan certain paper forms into the courts electronic case management system
to facilitate the timely filing of time-sensitive court forms filed by prison inmates
to facilitate the timely adjudication of certain basic court forms filed by prison inmates
the reduction or elimination of the tedious and time-consuming task of opening every envelope or package sent to a prison inmate
the reduction or-elimination of having to send prisoner mail to an off-site security sorting facility prior to delivery to the court

The invention further provides a method for effecting simultaneous receipt of a court form 36 forwarded by a “CSP”, and payment thereof, in the electronic currency system of the invention, comprising providing to a court data concerning payments made or, fractional payments to be made, and at the time intervals at which such payments are to be made, (according to the paradigm of the court) continuously verifying by the “CSP” that such fractional sums are received at the required time intervals, continuing to provide the court with data as long as said sums are received at the required time intervals, and discontinuing or suspending the provision of said services or goods provided by the “CSP” or said court if said fractional payments cease to be received.

It should also be appreciated that the court will have the added advantage of predetermining the type and quantity of court form 36 that may be viewed and accessed by the prison inmate. FIG. 3. Thus, obviating administrative and security concerns.

To that extent a means to provide prison inmates' with the capability of electronically forwarding certain court forms 38 to the court would offer a solution to longstanding prison administrative and security concerns. See e.g., Federal Bureau of Prisons, Policy Statement 5800.16, Apr. 5, 2011, ¶1.3 (“Staff will open all incoming mail, newspapers, magazines, books, and packages and inspect the material for contraband prior to distribution.”) Further, a means to provide prison inmates' with the capability of electronic forwarding certain court forms 36 would generally reduce the workload and work hours of those prison staff members' tasked with sorting, cataloging, inspecting, and delivering prisoner mail. See e.g., Federal Bureau of Prisons, Policy Statement 5265 14, Apr. 5, 2011, 306 (“Special and legal mail is afforded priority and every reasonable effort shall be made to assure delivery of special mail within 24 hours. Delivery time is essential in the filing of court forms or other legal papers, therefore. Mail room staff, as well as staff making the actual delivery to the inmate (usually unit staff), must adhere to delivery time frames for special mail. “Staff shall open inmate special mail in the inmate's presence. Staff are to check for contraband and funds at this time. *** Mail room staff shall maintain a log detailing receipt and delivery of special mail. Additionally. special/legal mail shall be time-stamped, or a handwritten note shall be made on the envelope, to show date and time received in the mail room,”)(Emphasis in original).

### Alternative Embodiments

According to some of the exemplary embodiments contemplated, the systems and methods of this invention leverage existing communication networks. For example, the client machine 22 could communicate with the client server 20 via the zero/thin client networks typically installed in prison and correctional environments. Or, such communication networks may be fixed wireless broadband (cellular) or wireless fidelity (WI-FI) using say, the 802.11n technology. Thus, in accordance with a Wi-Fi embodiment, the system may be further enhanced with WI-FI Protected Access 2 (WPA2) which in addition to providing additional security also authenticates the profile of the prison inmate attempting to access the system, in accordance with an exemplary embodiment of the WI-FI network, the client server 12 could be an authentication sever with the 802.1X technology.

According to another embodiment, the court form 38 may be created using Extensible Markup Language (XML). XML allows a page to contain a definition and execution plan for the elements, as well as their content. XML enabled forms may also be protected through Digital-rights Management (DMR) encryption. DMR is a digital lock that prevents unauthorized tampering.

In an application of one exemplary embodiment, after a basic court form 36 has been selected by the prison inmate, the Web server 10 will embed the prison inmates' name, unique prison identification number, photograph, and postal address of the prison where the inmate is currently lodged on the selected court form 36. FIG. 4: For example, the automatic insertion of the prison inmate's name and registration number could be completed using the AutoComplete available via Microsoft's Internet Explorer. The prison inmates' unique identification information would typically be confirmed by the Web server 10 before the electronic transfer of any court form 36 to a court

In an application of another exemplary embodiment, the URL of the low-level court 28, mid-level court 30 or high-level court 32 can be configured to accept only case numbers (oftentimes referred to as docket numbers) of cases originating in their court, in this embodiment, the prison inmate may only access the database of court forms 36 (or other court Information, such as the prison inmate's docket sheet) after inserting his/her case number at the client machine 22.

In accordance with an example of one embodiment, the prison inmate could simultaneously exchange payment for goods and services rendered by use of the invention via a debit card purchased in the prison's commissary; a debit card associated with a debit-card reader associated with the client machine 22. According to another embodiment of the invention the data storage medium in which the active data packets are provided is a smart card located in a smart-card reader associated with the client server 20, or other terminal associated with the prison inmate 22.

According to one exemplary embodiment, the client machine 22 will provide the prison inmate with an option to save the completed court form 38 as a “dynamic file.” A “dynamic file” is a file that may be modified prior to each transfer. The completed (or partiaily completed) court form 38 can be stored on the server 24 of the “CSP”. Or else, the court form 38 can be saved to a cloud-based storage service similar to that offered by Dropbox, Inc. of San Francisco, Calif. or ViaWest of Greenwood Village, Colo.

In the event the prison inmate had not completed the court form 36 previously, the incomplete form may be presented to the prison inmate with populated fields (spaces) highlighted so the prison inmate can readily determine what data remains to be entered. In the preferred embodiment, i.e., storing the completed or partially completed court form 36 at a cloud-based storage component (or at a hybrid cloud) the court form 36 would be available for visual retrieval by the prison inmate at any client machine 22 within the prison system. A “hybrid cloud” can be any combination of two or more public, private or community clouds. In this embodiment, the court form 38 could only be retrieved using the unique profile indicia of the prison inmate. The prison inmate may continue to enter data in the spaces 38 of the court form 36 and then forward the court form 36 to a selected court.

According to another preferred embodiment, the Web server 10 may also contain a database of district attorneys and/or attorneys of record. Prison inmate access to an expanded database could be accomplished using the Open Database Connectivity know-how. Open Database Connectivity is a technology that programmers use to access a wide range of databases (or data sources). In such a circumstance, the court form 38 may also be electronically forwarded to those authorized attorneys.

In yet another preferred embodiment, the preformatted court form 36 available may be expanded to include other types typically needed by prison inmates, such as a Petition for Commutation or Pardon. In this embodiment, the court form 38 or other expanded type form, could be locally produced and cached on the server of the “CSP”.

In yet another alternative embodiment, the Web server 10 may also be linked to the system and database whereby certain prison inmates have access to e-mail communication such as that provided for Federal prisoners through Corrlinks Advanced Technology Group, LLC of West Des Moines, Iowa. In accordance with this embodiment, the prison inmate can receive an automatic e-mail message receipt generated from the servers' low-level court(s) 28; mid-level court(s) 30 and high-level court(s) 32 using, for example, the courts CM/ECF, further reducing or eliminating administrative and security concerns. For example, Federal Bureau of Prisons policy states that its electronic messaging “program Objectives” are: 1) “[t]o provide inmates with an alternative means of written communication with the public; 2) [t]o provide the Bureau with a more efficient, cost-effective, and secure method of managing and monitoring inmate communications; and 3) “[t]o reduce the opportunities for illegal drugs or contraband to be introduced into Bureau facilities through inmate mail.” (Federal Bureau of Prisons, Policy Statement 5265, 13).

### Summary

The objectives of one or more aspects of the present system and method are to 1) provide prison inmates with a fundamentally new and better method of access to certain basic court forms intended to be filed with the courts; 2) facilitate the filing and adjudication of certain basic court forms filed by prison inmates, 3) the reduction and or elimination of scanning certain basic requests from paper to electronic format by court personnel, and 4) to offer a solution to a long-standing prison administrative and security concern with respect to prison inmate mail.

It is still another object of the invention to provide a suitable Interface or device and accompanying apparatus useful in exploiting the invention. This includes, but is not limited to, a computer kiosk with touch-screen capabilities designed specifically for prison inmate use.

It is a further object of the invention to provide electronic money and systems employing it which can be used for carrying out transactions over the Internet.

It is a further object of the invention to provide a system and method which can be used for the simultaneous service of receipt/payment for goods and services, and which can further tee used to support the validity of court forms 38 electronically forwarded.

### CONCLUSIONS, RAMIFICATIONS AND SCOPE

Thus, the reader will see that according to one or more embodiments of the system, method and device contemplated, I have provided a system and method that has the potential to effect whole-scale changes in prison and/or correctional environments and how prison inmates communicate and interact with the court systems.

While the above description contains many specificities, these should not be construed as limitations on the scope, but rather as an exemplification of several embodiments thereof. Many other variations are possible. Furthermore, despite the fact a preferred embodiment of the present invention has been shown and described, it will be apparent to those skilled in the ad that many changes and modifications may be made without departing form the invention in its broader aspects. Because the computer and computer network fields are changing rapidly, it is expected that implementation of the invention will change significantly as technology evolves. The particular programming language and the type of database can be varied depending on the preferences of the programmer. Such changes in implementation, however, do not depart from the spirit and scope of the invention.

1. An internet content delivery service for prison inmates' operative in a computer network, the method comprising:
a) providing a prison inmate with a client machine with a graphical user interface in combination with a control element means for entering data in response to prompts on said graphical user interface, said client machine connected to a first communications medium, said first communications medium connected to a server component of a third-party form provider, said server component of said third-party form provider connected by a second communications medium to a server of a first-party form provider;
b) receiving a request at said server component of said third-party form provider from said prison inmate for a form, said request made via said control element via said client machine, via said first communications medium;
c) obtaining a template of said requested form from said server of said first-party form provider, each said form being comprised of at least one of predefined text data, said predefined data representative of one or more requests for judicial action, said obtainment being made via said second communications medium;
d) replicating said form to said server component of said third-party form provider in combination with a data processor means of linking said predefined data to said form, causing said form to be interactive for said prison inmate, in combination with a graphics processor means programmed to embed additional data such as text and digital images comprised of pixels in said form, said embedded data delimitative to a prisoner profile;
e) caching said replicated form on said server component of said third-party form provider, said cached replicated form being available for subsequent requests for said form by said prison inmates;
f) providing said replicated, embedded form to said prison inmate via said first communications medium, via said client machine, in response to action by said prison inmate at said control element, said control element allowing said prison inmate to interact and manipulate said replicated and embedded form by inserting a plurality of digits and a plurality of characters via said control element, said control element forwarding said manipulated form to server component of said third-party form provider via said first communications medium;
g) receiving at said server component of said third-party form provider said manipulated form from said prison inmate via said first communications medium, said manipulated form containing said plurality of digits and said plurality of characters, said received form validated by said data component of said server component of said third-party form provider:
h) accepting from said prison inmate an electronic payment in the form of a debit credit for an amount associated with said manipulated form via said first communications medium;
i) forwarding said manipulated form containing said plurality of digits and said plurality of characters to said server of said first-party form provider via said second communications medium, said plurality of digits and said plurality of characters conveying the Intent of said prison inmate to said first-party form provider,
whereby said communications medium will facilitate the adjudication of legal matters between principals while offering a solution to a long-sought administrative and security need by the courts and prison staff with respect to prison inmate mail.

2. A method of processing documents over a computer network aimed at prison inmates, the documents being processed by a third party document servicer that is neither one of the document's provider's, nor one of the document's users, the method comprising the steps of:
a) presenting a document replicated from a database of one or more first-party document providers to a prison inmate over a computer network by a third-party form engine, said form engine modifying said document to include interactive spaces for said prison inmate to augment said document with data via a client machine, in combination with a display and control element means, said third-party document servicer subsequently retrieving said document from said prison inmate via said computer network, said server of said third-party document servicer validating said data entered by said prison inmate, after which said third-party document servicer transfers said replicated document to database of said first-party document provider;
b) receiving by the third-party document servicer over said computer network said prison Inmate information and electronic payment information submitted by said prison Inmate with respect to said document posted to said first-party document provider database;
c) processing by the third-party document servicer said electronic payment associated with said document, said electronic payment constituting debit credits from a prison inmate trust fund account to said one or more said first-party document provider databases to which said document is directed,
whereby said framework causes an affective and efficient distribution of documents between parties while reducing the amount of administrative work and paperwork produced by the court and the prison inmate.

3. A method of filing a document on behalf of an individual, the method comprising the steps of:
a) maintaining a digital document catalog under the control of a server system, said server system being connected to a server computer said server computer comparing additional information programmed for one or more individuals previously identified by a plurality of digits and a plurality of characters indicia of said individuals profile, said profile programmed in a client computer, said client computer in combination with a display and control elements means allowing said individual manipulate one or more documents cached on said server system, said manipulation consisting of one or more plurality of digits and a plurality of characters, said one or more plurality of digits and a plurality of characters conveying the intent of said individual, said intent of said individual being made known to a third-party via receipt of said document via said server system,
whereby such individual has an effective method to forward documents electronically.
